(19) United States
(12) Patent Application Publication
(10) Pub. No.: US 2024/0273214 A1
(43) Pub. Date: Aug. 15, 2024

(54) ARTIFICIAL-INTELLIGENCE-BASED SYSTEM AND METHOD FOR QUESTIONNAIRE / SECURITY POLICY CROSS-CORRELATION AND COMPLIANCE LEVEL ESTIMATION FOR CYBER RISK ASSESSMENTS

(71) Applicant: NormShield, Inc., Boston, MA (US)

(72) Inventors: Candan Bolukbas, Stone Ridge, VA (US); Muzeyyen Gokcen Arslan Tapkan, Istanbul (TR); Gulsum Budakoglu, Kecioren Ankara (TR); Ferhat Dikbiyik, Hopkinton, MA (US); Robert Maley, Chandler, AZ (US)

(73) Assignee: NormShield, Inc., Boston, MA (US)

(21) Appl. No.: 18/167,848

(22) Filed: Feb. 11, 2023

(51) Int. Cl. G06F 21/57

(52) U.S. Cl. CPC G06F 21/577

(57) ABSTRACT

A method of cyber risk assessment includes uploading a user cybersecurity standard comprising a user compliance item represented by text and converting the text to a numeric array to generate an embedded user compliance item. A standard compliance item represented by text is retrieved from a standard database. The text to a numeric array is converted to generate an embedded standard compliance item. The embedded user compliance item and the embedded standard compliance item are correlated to generate a compliance item map. A digital footprint of an entity based on an associated domain name is discovered using non-intrusive information gathering. An entity technical finding is generated based on the discovered digital footprint of the entity and a control item. An entity compliance level estimate is computed. A computer process of the entity is then adjusted based on the computed entity compliance level estimate.

The section headings used herein are for organizational purposes only and should not be construed as limiting the subject matter described in the present application in any way.

### INTRODUCTION

Organizations execute audits for their vendors in terms of cybersecurity with multiple methods. One of the most common methods is sending questionnaires to their vendors to assess the cyber-risks of the vendors and to determine the cybersecurity maturity levels of the vendors based on the answers collected. In the absence of automation tools, the process of such audit (i.e., sending questionnaires to vendors, gathering answers, analyzing the answers) is labor-intensive.

While organizations assess the cyber-risk of their vendors to understand their compliance level of such well-accepted standards, vendors working with multiple organizations have to respond questionnaires sent from different organizations in different formats and contents. Automated and/or computer-based solutions are needed to improve the efficacy and efficiency of the cyber-risk assessments.

Moreover, there can be significant improvements in efficiency and efficacy if these cyber-risk assessments are implemented in an automated and context-aware fashion eliminating the need for a manual analysis by a domain-expert, which can be, for example, a cybersecurity expert.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1A illustrates a block diagram of an embodiment of a cyber-risk assessment system that cross-correlates various cybersecurity standards and frameworks along with user-submitted questionnaires and security policies to estimate compliance level of an entity to various standards, frameworks, and regulations with non-intrusive data gathering and risk scoring according to the present teaching.

FIG. 1B illustrates a block diagram with subsystem detail of an embodiment of a cyber-risk assessment system that cross-correlates various cybersecurity standards and frameworks along with user-submitted questionnaires and security policies to estimate compliance level of an entity to various standards, frameworks, and regulations with non-intrusive data gathering and risk scoring according to the present teaching.

FIG. 2 illustrates a flow diagram of an embodiment of a system that estimates the compliance level of an entity based on a source document according to the present teaching.

FIG. 3 illustrates a flow diagram of an embodiment of a system that creates a list of items from a source document according to the present teaching.

FIG. 4 illustrates a block diagram mapping a source document to a specific pivot document and estimating the compliance level according to the present teaching.

FIG. 5 illustrates a flow diagram of an embodiment of a method for an example mapping from a source document to multiple pivot documents and multiple destination documents according to the present teaching.

FIG. 6 illustrates a flow diagram of an embodiment of a method compliance level calculation according to the present teaching.

FIG. 7 illustrates a block diagram estimating the compliance level with technical findings obtained through non-intrusive data gathering according to the present teaching.

FIG. 8 illustrates an embodiment of a process for manual classification of the cybersecurity data for a cyber-aware artificial intelligence engine according to the present teaching.

FIG. 9 illustrates an embodiment of training and model set up for a cyber-aware artificial intelligence engine according to the present teaching.

FIG. 10A illustrates part of a table showing the mappings of an uploaded file to a General Data Protection Regulation (GDPR) at an output of a document parser engine according to the present teaching.

FIG. 10B illustrates a continuation of the table showing the mappings of an uploaded file to a General Data Protection Regulation (GDPR) at an output of a document parser engine of FIG. 10A.

FIG. 11A illustrates a continuation of a table showing the mappings of an uploaded file from a National Institute of Standards and Technology (NIST) standard at an output of a document parser engine according to the present teaching.

FIG. 11B illustrates a continuation of the table showing the mappings of an uploaded file from a National Institute of Standards and Technology (NIST) standard at an output of a document parser engine of FIG. 11A.

FIG. 12A illustrates a table showing the effect of the compliance and completeness level of standards at an output of an embodiment of a policy examiner system according to the present teaching.

FIG. 12B illustrates a continuation of the table showing the effect of the compliance and completeness level of standards at an output of an embodiment of a policy examiner system of FIG. 12A.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments as long as the teaching remains operable.

Using questionnaires and compliance control item lists with different contents and formats creates a major challenge for both organizations that perform cyber risk audits/assessments and vendors that are being assessed. An organization works with multiple vendors (on the scale of hundreds), and a vendor provides services to multiple organizations. As a result, vendors receive different questionnaires that need to be completed. Even if the questionnaires and compliance control item list used are in their original format (i.e., Shared Assessments' SIG Questionnaire or Cloud Security Alliance's Cloud Controls Matrix), most companies tend to use a modified or custom version that can make the assessment process labor intensive and complicated.

Many vendors prefer to share their established policies or their particular version of a questionnaire and place the burden on their clients to parse and analyze their documents for answers to their questions. The process, as it exists today, is tedious and requires an unreasonable amount of time and effort for both parties involved.

Organizations prepare their questionnaires and compliance control item lists based on certain cybersecurity standards, frameworks, and regulations such as US National Institute of Standards and Technology (NIST) SP 800-53, Control Objectives for Information and Related Technology (COBIT 5), International Organization for Standardization/International Electrotechnical Commission (ISO/IEC) 27001, European Union's the General Data Protection Regulation (EU GDPR), the Payment Card Industry Data Security Standard (PCI DSS), etc. The questions may vary from standard-to-standard and also from organization-to-organization. The efforts on standardization of such questionnaires are made by several organizations such as Shared Assessments or Online Trust Alliance. Despite the efforts, the content of the questionnaires and the number of questions varies.

The term “standard” used herein refers a cybersecurity standard, framework, or a regulation or a questionnaire derived from a cyber-cybersecurity standard, framework, or a regulation. The standard can be converted to list of items that serves as a cybersecurity checklist or control list to determine the cybersecurity maturity level of an entity. A security standard can, for example, provide insight to implement network controls and provide remedies or computer hardware and software systems that address security threats and/or vulnerabilities. By determining a level of compliance to a standard a user can, for example, provide a set of computer system best practices that can be implemented in hardware and/or software to ensure future compliance or to remedy a non-compliant system. An example overall goal of implementing a compliance level estimation system is to reduce the risk that common, known and/or emerging cybersecurity threats will impact the computing infrastructure owned and/or operated by a user.

One feature of the apparatus and method of the present teaching is that it addresses the challenges in a way that it can consume a wide variety of questionnaires and internal policies, e.g., Information Security Policy, and map the contents to well-known standards and frameworks such as NIST 800-53, ISO27001, or CMMC within the context of cyber security and Information Security.

Another feature is that the embedded modelling engine is made using an artificial intelligence (AI) mechanism that is able to understand and evaluate English based text in the cybersecurity and Information Security context. The AI behind the embedding modelling engine can be trained with a large cybersecurity dataset, and hence could be referred to as cyber-aware AI. This can be done based on a fine-tunable natural language processing (NLP) model. For example, bidirectional encoder representations from transformers (BERT) can be used, or another known transformer-based language model can be used. The AI mechanism is continuously fed by the Compliance Level Estimation System and Standards and Framework Database System. A key insight that informs the method and system of the present teaching is that NLP models and systems are now available with features and performance that can be applied to the process of training embedding models of the present teaching. Embedding models of the present teaching rely heavily on text and other human-language attributes and can be improved using NLP technology.

In some embodiments, when a user of the system and method in the present teaching has a custom questionnaire or the information security policy of a vendor, the system parses and processes the source document and maps the results to the controls in each relative standard defined in the system automatically.

With the system and method in the present teaching, the cross-correlation between multiple standards and custom questionnaires/security policies eliminates the needs of vendors to answer different questionnaires from various organizations.

One aspect of the present teaching is the use of technical findings gathered with non-intrusive methods to estimate the compliance level of an entity in the absence of any response (e.g., a completed questionnaire) from a vendor. The compliance information can be used, for example, to remediate any non-compliant issues that are uncovered by the compliance estimation. Remediation can include, for example, removing, changing or otherwise modifying a cyber element relating to the non-compliance issue. Cyber elements can include, for example, a security process or device, computing process, network, software and/or software versions, storage and/or data transmission method or system, user authentications, user roles, and other known cyber elements. As understood by those skilled in the art, the examples listed above are not necessarily unique and may overlap. It should be understood that the present teachings can be embodied in various methods, systems and/or non-transitory computer readable storage medium.

The term “non-intrusive” as used herein refers to the commonly understood meaning of the term applied to the collection of data over a network. The concept of non-intrusive data gathering is described in Open Source Intelligence (OSINT) documents. In particular, security assessments are described in certain NIST publications, such as NIST Special Publication No. 800-115 in, for example, Sections 2.3 and 2.4. In addition, the concept for non-intrusive data gathering is described in the MITRE's ATT&CK framework, in particular under the Technical Information Gathering section. See, for example, the description of acquiring of OSINT data sets and information.

One example of what we mean by non-intrusive gathering of data over a network is to collect data without requiring the active participation of the entity associated with the data. This generally means that no human intervention is required. Another example of what we mean by non-intrusive gathering of data is to collect data with minimal or essentially no interruption to the operation of the entity associated with the data. That is, the non-intrusive gathering of data essentially does not disturb the entity associated with the data in a significant way and generally does not require active participation persons associated with the entity. It should be understood that the meaning of non-intrusive gathering is not based on whether or not permissions are granted from an entity. Permissions are not particularly relevant as cyber criminals do not ask for permission.

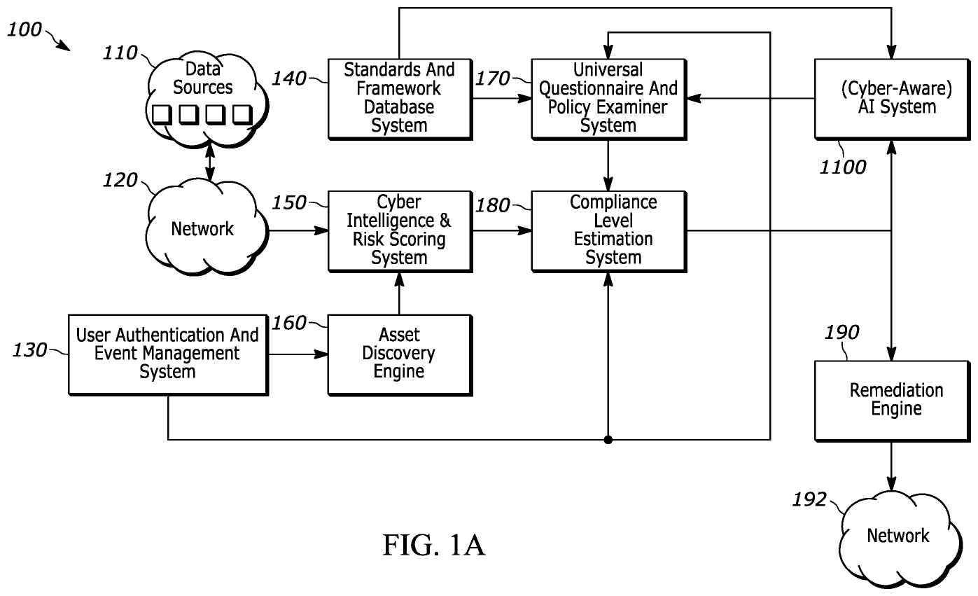

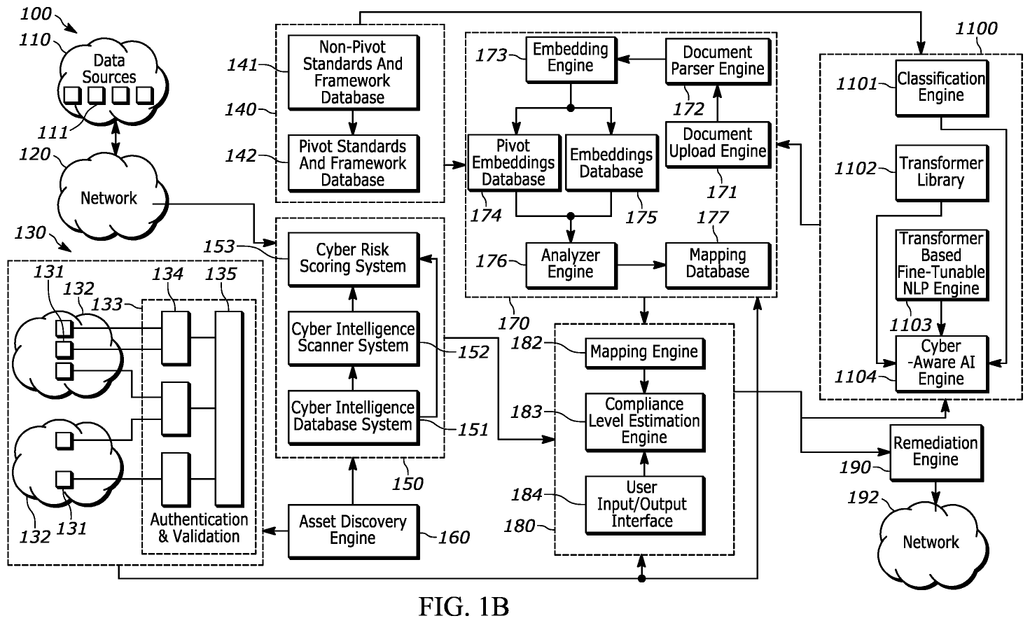

FIG. 1A illustrates a block diagram of an embodiment of a cyber-risk assessment system 100 that provides non-intrusive data gathering, compliance level estimation, and cross-correlation between multiple industry-accepted cyber security standards and user-submitted custom questionnaires and security policies according to the present teaching. The system 100 relies on information non-intrusively gathered from a variety of data sources 110 that are publicly and/or privately accessible. The data sources can be, for example, any data source that is free-to-use and/or a paid/subscriber-based source. For example, data sources can include data providers, websites, internet forums, web crawler, honeypot, data collector, internet-wide scanners, news sites, paste sites, regulatory authorities, reports, social sites, and/or internet sits residing in the deep web or darknet. The data sources 110 are reachable through a communication network 120 that is also connected to computer resources that are used to execute the method of cyber risk assessment and implement the cyber risk assessment system 100 according to the present teaching. The data in these data sources 110 can include text and human-language-based items that require further processing in order to generate useful models that are based on this data and that can be used for cyber risk assessment.

A user authentication and event management system 130 receives requests from users. In some methods according to the present teaching, users initiate a request for a cyber-risk assessment of an entity that is associated with a particular domain name. The entity may be a third-party entity so that the user can obtain a cyber-risk assessment of the third-party's cyber risk.

The user authentication and event management system 130 is in communication with an asset discovery engine 160. The term engine as used herein refers to software that executes codes to perform certain calculations based on given inputs and the computer resources used to execute that software. The computer resources used to execute the application may refer to, but are not limited to, partial resources of hardware associated with a computer system that has one or more CPUs, RAMs, ROMs, data storage units, I/O adapters, and communication adapters.

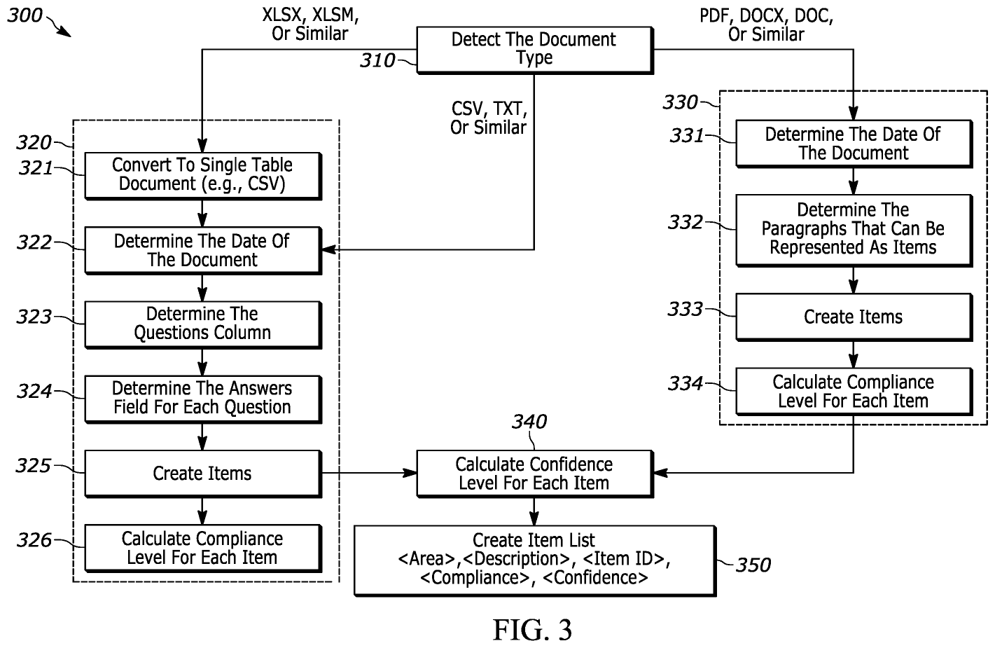

In some methods according to the present teaching, the asset discovery engine 160 discovers a digital footprint of the entity based on the associated domain name and based on non-intrusively gathered information from a computer network 120 and from various connected data sources 110. The user authentication and event management system 130 is also in communication with a universal questionnaire and policy examiner system 170, which parses a user-submitted or existing document and calculates embeddings. The term “embedding” as used herein, is a 512-dimensional array to represent an item. The element of each array is a double value, which is a number in computer number format called as double-precision floating-point format represented with 64 bits. The term “item” as used herein is a descriptive text including five elements as shown in the create item list 350, which is described later in FIG. 3.

The asset discovery engine 160 is in communication with a cyber-threat intelligence and scoring system 150 that fetches a list of control items that are generated using the non-intrusively gathered information from the computer network 120 and from the data sources 110 and that is based on the discovered digital footprint of the entity and also produces technical findings from non-intrusively gathered data. The list of control items includes items that need to be checked to assess the cyber risk of an entity. For example, the list of control items can be updated based on various information, such as open standards, regulations, frameworks, internal data, or any other various information from one or more of the data sources 110 that provides such control items and their related parameters, such as the severity, technical impact, likelihood of exploit, etc. through network 120. The entity's technical findings that are based on the control items can be used to assess the compliance of, for example, a network security process, a threat detection process, a data storage process, and a data transmission process of the entity.

The cyber-threat intelligence and scoring system 150 can also generate a list of standards control items updated based on various information, such as open standards, regulations, frameworks, internal data, or other information from one or more of the data sources 110 that provide such control items. The control item information can also include control item related parameters, such as, for example, the severity, the technical impact, the likelihood of exploit, and other related parameters. The data sources 110, can provide the information through network 120 and the standards control items information can be used to generate a computed level of compliance of an entity for multiple standards.

The term “database” as used herein refers to one or more data storage units that reside in a local computer system (e.g., residing in a local server) and/or in whole or in part in a distributed cloud environment (e.g., residing in servers or blades located in the cloud). The storage units are connected to input/output adapters that write and read information. These distributed storage units can be accessed with the use of database management software (DBMS), which is a computer program that interacts with end users, applications, and the database itself to capture and analyze the data. The servers and/or blades are the physical hardware that preferably have one or more data storage drive (e.g., hard disk drive), processors (CPUs), power supply units, cooling units, and communication adapter (network interface).

The asset discovery engine 160, the universal questionnaire and policy examiner system 170, and the cyber intelligence and risk scoring system 150 are all in communication with a compliance level estimation system 180. The compliance level estimation system computes the level of compliance for multiple standards based on scored technical findings produced by the cyber intelligence database system 150 in the absence of user inputs. This computed level of compliance for multiple standards is referred to as a standard level of compliance. Note that the standard level of compliance that is output from the compliance level estimation system 180 comprises various formats and/or data contents that depend on, for example, the multiple standards defined in the system and/or available from the data sources 110. The method and system of the present teaching processes the standard level of compliance data as described herein to determine an entity compliance level.

The compliance level estimation system 180 can compute the compliance levels with the user inputs and/or user-uploaded documents while mapping the results to multiple standards defined in the system. This computed level of compliance based on user data is referred to as a user level of compliance. Note that the user level of compliance that is output from the compliance level estimation system 180 comprises various formats and/or data contents that depend on, e.g., the user inputs and/or user-uploaded documents as well as the multiple standards defined in the system and as described herein. The method and system of the present teaching processes the user level of compliance data as described herein to determine an entity compliance level. The output of the compliance level estimation system 180, including the user level of compliance and standard level of compliance, can be provided to a remediation engine 190. The remediation engine 190 can make adjustments to various parts of the cyber infrastructure that can reside in a network 192 and that are associated with one or more entity being assessed. The adjustments can be based, for example, on the computed level of compliance in order to improve a security stance of cyber infrastructure associated with the one or more of the entities that are analyzed by the cyber-risk assessment system 100. Remediation can include, for example, removing, changing or otherwise modifying a cyber element relating to the non-compliance issue. In some embodiments the remediation includes adjusting the computer infrastructure (hardware and/or software) so that a new and/or improved compliance condition can be realized and/or changing the cyber security stance of one or more entities. The cyber elements may be part of and/or operating over a network 192. The network 192 may be in all or in part, the same as network 120.

A standards and framework database system 140 stores data of the items of each standard and framework defined in the system. The standards and framework database system 140 consists of at least two databases, a non-pivot standards and framework database 141 and a pivot standards and framework database 142, as depicted in FIG. 1B. The term “pivot standards and framework” used herein refers to standards and framework that are well-accepted, easy-to-parse by computer resources, high-coverage (in terms of scope) standards and framework that are generally known in the art. It should be understood that these particular databases are examples and don't limit the present teaching. Many other types of databases can be used. In various embodiments, the standards and framework database system 140 can be extended with other databases that provide valuable information to determine the compliance level. In some embodiments, the database includes compliance items that include, for example a network security process, a threat detection process, a data storage process, and a data transmission process that are executed on a computer processor. These compliance items can be referred to as standard compliance items.

The output of both the compliance level estimation system 180 and standards and framework database system 140, including the standard compliance items, is provided to the Cyber-aware AI system 1100. The cyber-aware AI system 1100 continuously evolves and improves based on the input from the two. The output of the cyber-aware AI system is an embedding modelling system for the Universal Questionnaire and Policy Examiner system 170.

FIG. 1B illustrates a block diagram with subsystem detail of an embodiment of a system that provides questionnaire/security policy cross-correlation and compliance level estimation for cyber risk assessment. The relevant data is gathered from data sources 110 that are publicly or privately accessible. The data sources can be any data source free-to-use or paid/subscriber-based source. For example, the particular data source 111 can be a data provider, website, forum, web crawler, honeypot, data collector, internet-wide scanner, news sites, paste sites, regulatory authorities, reports, social sites, a site residing in deep web or darknet (i.e., a website that can be reachable with only special tools, methods, etc.). That is, the particular data source 111 can be any data source that provides information about an “entity” and that can be reachable through a communication network 120. The communication network 120 can be one or more networks to which various databases in the cyber intelligence database system 150 are in communication with, including, for example, various public and private networks and internetworks that operate over a variety of wired and/or wireless infrastructure. One skilled in the art will appreciate that the term “entity” as used herein generally refers to any organization, corporation, firm, company, or institution associated with a network domain name.

FIG. 1B also includes compliance level request system 130 where users request compliance level results for a single entity or multiple entities. It should be understood that the entity whose cyber risk and compliance level is requested can be the entity of the user or a third party with whom that user's entity engage. The request system 130 is also used to upload a source document such as a custom questionnaire or a security policy document. The request system 130 includes user devices 131 that request and receive information. The user devices 131 can be located in one or multiple network domains 132. The user devices 131 can be any device that has the necessary hardware and software to log in to a cloud-based system. For example, any network-accessed processor-based device can be utilized including, but not limited to, personal computers, laptop computers, mobile devices, smartphones, and tablet computers.

User devices 131 communicate with an authentication and validation module 133 where user login requests are handled by login processes 134. After logging in, users can request cyber risk assessments and compliance level estimations for a single entity, or multiple entities, by giving the domain name(s) of the entity/entities as input(s). These user requests are handled (e.g., processed, scheduled, and initiated) by an event manager 135.

The domain names of an entity provided by the user in the user request are forwarded to an asset discovery engine 160 that determines the internet-facing assets of an entity using non-invasive techniques that require no human intervention. A determined description of all or nearly all of the internet-facing assets of an entity is referred to herein as a digital footprint. One skilled in the art will appreciate that the term “asset” as used herein generally refers to internet metrics such as domains, Internet Protocol (IP) addresses, blocks of IP addresses, subdomains, Domain Name Server (DNS) records, websites, Autonomous System Numbers (ASN), which is a unique number assigned to an autonomous system by the Internet Assigned Numbers Authority (IANA), web services, social media accounts, e-mail addresses, and/or other internet-facing element that belongs to digital footprint of an entity. An engine as described herein is a software application that executes code to perform certain calculations based on given inputs. These engines also include the computer resources used to execute that software, which can be, but are not limited to, computer hardware resources such as one or more of CPUs, RAMs, ROMs, data storage units, I/O adapters, and communication interfaces.

A cyber intelligence and scoring system 150 comprises cyber intelligence database system 151, cyber intelligence scanner system 152, and cyber risk scoring system 153. See, for example, U.S. patent application Ser. No. 16/855,282, entitled System and Method for Scalable Cyber-Risk Assessment of Computer Systems, which is assigned to the present assignee. The entire contents of U.S. patent application Ser. No. 16/855,282 are incorporated herein by reference. The cyber intelligence database system 151 non-intrusively gathers information from data sources 110 through the communication network 120.

At least some of the databases in the cyber intelligence database system 151 communicate with a cyber-intelligence scanner system 152 as further described U.S. patent application Ser. No. 16/855,282. The cyber intelligence scanner system 152 is also in communication with the asset discovery engine 140. The cyber intelligence scanner system 152 scans the information in the databases of the cyber intelligence database system 151 with respect to the outputs generated by the asset discovery engine 140.

The cyber intelligence scanner system 152 is in communication with a cyber-risk scoring system 153 and the outputs of the cyber intelligence scanner system 152 are sent to the cyber risk scoring system 153. The cyber risk scoring system 153 is also in communication with the cyber intelligence database system 151. The cyber risk scoring system 153 stores the technical findings that are output of cyber intelligence scanner system in one of its databases as further described in U.S. patent application Ser. No. 16/855,282. The cyber risk scoring system 153 produces scored technical findings. In some methods according to the present teaching, the cyber risk scoring system 153 relies on industry-related quantification parameters that are generated based on the entity technical finding and based on the entity classification. The outputs of the cyber intelligence scanner system 152 provide the results for each control item from the list provided by cyber intelligence database system 151 and these results are stored as technical findings. The technical findings are provided to compliance level estimation system 180.

A universal questionnaire and policy examiner system 170 is in communication with the compliance level estimation system 180, cyber-aware AI System 1100, standards and framework database 140, and the authentication and validation module 133. The universal questionnaire and policy examiner system 170 gets the document uploaded to the system with document upload engine 171 initiated by a request from the authentication and validation module 133. The document upload engine 171 determines the type of the document and transfers the document to a document parser engine 172. The term document used herein refers to a digital file that contains a cyber-risk assessment questionnaire or a cyber-security policy. The document parser engine 172 parses to document to represent it in a list of items and provides the list of items to an embedding engine 173. The embedding engine is in communication with the document parser engine 172 and the databases in the standard and framework database system 140. The embedding engine 173 produces the embedding results from the items input and stores the results in a pivot embeddings database 174 if the results are produced from items fetched from the pivot-standards and framework database 142. Otherwise, it stores the results in an embedding database 175. An analyzer engine 176 is in communication with both pivot embeddings database 174 and embeddings database 175, and also with a mapping database 177. The analyzer engine 176 correlates the embeddings received from pivot embeddings database 174 and embeddings database 175. The analyzer engine 176 stores the results in the mapping database 170 and inputs the mapping results to a mapping engine 182 that is a part of the compliance level estimation system 180. In this way, the universal questionnaire and policy examiner system 170 generates a compliance item map that can be used in subsequent processing to estimate compliance, for example, a cyber security compliance level of an entity as requested by a user.

The compliance estimation system 180 is communication with the universal questionnaire and policy examiner system 170 through the mapping engine 182, and with the authentication and validation module 133 through a user input interface 184. The graphical user interface in user input/output interface 184 in some embodiments allows users to manipulate the results by changing the parameters affecting the results. If a change is requested, a user provides the request from the user device 131 and the event manager 135 delivers this request to a compliance level estimation engine 183. The compliance level estimation engine 183 computes the compliance levels of an entity whose results are requested for multiple standards based on the mapping results provided by the mapping engine 182. If the results are manipulated with the user input/output interface 184, the compliance level estimation engine recalculates the results. The compliance level estimation engine 183 sends the results user input/output interface 184 to display the results to the system users in a graphical user interface.

The compliance level estimation system is in communication with cyber-aware AI system 1100 to provide feedback to the AI algorithm for self-learning purposes. The cyber-aware AI system 1100 uses, for example, calculated user compliance levels and/or standard compliance levels for self-learning purposes. Users can provide feedback through user authentication and event management system 130 and the feedback data is processed by compliance level estimation system 180 and forwarded to cyber-aware AI system 1100.

One feature of the present teaching is that the risk assessment supports the ability to change the cyber security stance of an entity. This can be accomplished using the remediation engine 190 to adjust a cyber element residing in, for example, a network 192 and associated with one or more of the entities being analyzed. The network 192 may be the same, in all or in part, as any or all of networks 120, 110, 132. As described herein, the entity technical findings can be, for example, a misconfiguration of a computer hardware of software system of the entity, a computer hardware or software asset vulnerability, a computer hardware or software threat, a data loss, and a cyber-event associated with the entity, and/or a result in a particular compliance level estimation for that entity. The compliance level estimate is based on one or more cybersecurity standards that can include an accepted, published industry or government standard or a user-generated standard. A cybersecurity standard includes various compliance items such as network security processes, threat detection processes, data storage processes and others implemented by the computer infrastructure associated with the entity. Each standard contains its own set of compliance items. However, in general compliance items fall into categories including, e.g. endpoint security, data protection, network security, and others. As a result, if two standards are used by the system, those two standards can include compliance items of the same compliance item type. When this occurs, some embodiments of the system and method of the present teaching eliminate the redundancy and thereby provide an improved compliance level estimate.

The compliance level estimation can be used in some embodiments to adjust the computer infrastructure (hardware and/or software) so that a new and/or improved compliance condition can be realized. In some embodiments, this results in an improved compliance level estimation. For example, a network security process, a threat detection process, and/or a data storage process can be adjusted based on the compliance level estimation. For example, a particular computer hardware or software asset vulnerability of an entity can lead to low compliance in for example, one or more specific threat detection processes and/or one or more network security processes. By remediating at least some of the asset vulnerability, modifying the one or more specific threat detection processes and/or one or more network security processes, a subsequent risk assessment can be performed to result in an improved compliance level estimation for the entity.

One feature of the present teaching is that it is compatible with industry standards. Some embodiments of the present teaching use the standards and guidelines from ISO, HIPAA, NIST, the European Union General Data Protection Regulation (GDPR) and Payment Card Industry (PCI) may be included. In addition, inputs and assessments related to best practices, solutions and tools for third party risk management from Shared Assessments Group may be included.

One feature of the present teaching is that an initial compliance level estimation request proceeds automatically with only information about domain name or domain names associated with an entity. The system is able to calculate a compliance level for some of the items in multiple standards by only passive, non-intrusive data gathering.

In some embodiments, a user initiates a compliance level estimation request, and the system provides compliance level estimations related to the request. As an example, a user is connected to the system through a device 131 that is inside a network 132 and inserts his/her login credentials to a login user interface 134. The authentication and validation module 133 checks the login credentials and, if valid, the user interface illustrates an entry point where the user can provide the domain name of an entity to receive a compliance level estimation for that entity. The user inserts the domain name of the entity of interest. For this example, the domain name is examplesite.com for an entity of interest called Example Corporation (Example Corp.). The event manager 135 schedules this compliance level estimation request for the next available time in the system. Based on the availability of computer system resources, the waiting time can be less than or equal to a millisecond. In general, waiting times can be on the order of a few milliseconds, although longer waiting times are also possible.

When the system resources are available, the event manager 135 pushes this request to the asset discovery engine 160. The asset discovery engine 160 pulls the digital footprint information about Example Corp. from the cyber intelligence database system 151. The digital footprint information includes, for example, the domain names (e.g., examplesite.com), IP addresses (e.g., 91.195.240.126), subdomains (e.g., community.examplesite.com, orums.examplesite.com, etc.), domain name server (DNS) Records (which includes, for example, A records, MX records, Namerservers, and any other related records), services (e.g., HTTP, FTP, Telnet/SSH, etc.), servers and/or their versions used by the entity (according to information gathered from data sources 111), social media accounts of the entity (including, but not limited to, Twitter, Facebook, Linkedin accounts), AS numbers (e.g., AS47846), and/or e-mail addresses (e.g., forms@examplesite.com).

After obtaining the digital footprint information, the asset discovery engine 160 triggers cyber intelligence scanner system 152 by giving a digital footprint of the entity as inputs. All the scanners in the cyber intelligence scanner system 152 executes their search on the related databases in the cyber intelligence database system 151.

The results provided by the scanners in the cyber intelligence scanner system 152 are referred to herein as technical findings. The technical findings are provided by the cyber intelligence scoring system. The technical findings are sent to mapping engine 182 in the compliance level estimation system 180 as well. The technical findings are associated with the entity. For example, technical findings can include a misconfiguration of a computer hardware or software system of the entity, a computer hardware or software asset vulnerability, a computer hardware or software threat, and a data loss, and a cyber-event associated with the entity.

The mapping engine 182 fetches the mapping results from the mapping database. The mapping results consists of mapping between technical findings and pivot standard items. Each mapping result includes the source item ID (technical finding ID in this case), the answer estimation based on the result of technical finding, confidence level, destination standard ID (ID of one of the pivot standard), and destination item ID. The term confidence level used herein refers the statistical value computed from statistics and observed data and it measures the similarity between the technical finding and the item in the standard based on the mapping stored in the mapping database 177. If the confidence level for a specific item is under a certain threshold, e.g., 10%, then that item is left unanswered.

The compliance level estimation engine 183 then computes the compliance level for each pivot standard based on the mapping results between the technical findings and pivot standards provided by mapping engine 182. The term “compliance level” used herein refers the ratio of items with acceptable answers over the number of total answered items in the standard and it is shown in percentage.

System users can manipulate the answers by using user input/output interface 184 and request a re-calculation. In this case, the compliance level estimation engine 183 first recalculates the results for the standard on which the user manipulated the answers. Then, the engine recalculates the compliance level for all the other standards defined in the system.

The system is applicable to insert additional standards. System admin can insert the items of new standards into standards and framework database system 140. If system admin determines the standard as a pivot standard, then it is inserted in pivot standards and framework database 142. Otherwise, it is inserted in non-pivot standards and framework database 141. Then, the embedding engine 173 fetches the items on newly inserted standard and calculates the embeddings. The embedding results are stored into a pivot embeddings database 174 if the inserted standard is determined as pivot. Otherwise, the embedding results are stored in embeddings database 175. Then, an analyzer 176 fetches the embedding results of the newly inserted standard and cross-correlates with pivot embeddings. Each item of the newly inserted standard is mapped to one or more items of one or more pivot standards. The mapping results are stored in mapping database 177.

Another user scenario of the system in the present teaching is the case that a user can upload an answered custom questionnaire or a security policy to receive compliance level estimation for standards, framework, and regulations defined in the system. The user initiates a compliance level estimation request, and the system provides compliance level estimations related to the request. As an example, a user is connected to the system through a device 131 that is inside a network 132 and inserts his/her login credentials to a login user interface 134. The authentication and validation module 133 checks the login credentials and, if valid, the user interface illustrates an entry point where the user can provide the domain name of an entity to receive a compliance level estimation for that entity. The user uploads a document by using document upload engine 171.

After the user upload, the document upload engine 171 determines the type of the document and delivers it document parser engine 172. Document parser engine 172 itemizes the document. The list of items is delivered as an input to embedding engine 173. The embedding engine 173 calculates embeddings for the items parsed from the document uploaded and stores the data in embeddings database.

An analyzer engine 176 fetches the results in the embeddings database 175 and pivot embeddings database 174 and cross-correlates the results to map an item from the source document to one or more items in one or more pivot standards. The results of mapping are stored in mapping database 177. The mapping engine 182 fetches the mapping results of the source document to a pivot standard from the mapping database 177 and sends the results to the compliance level estimation engine 183. The compliance level estimation engine 183 computes the compliance levels for the pivot standard selected. The mapping engine 182 sends the mapping results of the source document to next pivot standard from mapping database 177 and sends the results to the compliance level estimation engine 183. The process is repeated for all the pivot standards.

The mapping engine 182 then sends the mapping results of pivot standards to non-pivot standards one by one to the compliance level estimation engine 183. At the end, the compliance levels for each standard defined in the system will be computed and can be displayed by a user.

A classification engine 1101 classifies and labels data to prepare it for cyber-aware AI engine 1104 in the cyber-aware AI system 1100. The transformer library 1102 in Cyber-aware AI System 1100 stores library entries for AI algorithms and gives inputs to the cyber-aware AI engine 1104. Transformer-based fine-tunable Natural Language Processing (NLP) engine 1103 provides data models trained by cybersecurity documents. It is in communication with cyber-aware AI engine 1104. Cyber-aware AI engine 1104 provides fine-tuned model results to embedding engine 173 in the form of an embedding modelling system that can be used in the embedding engine 173.

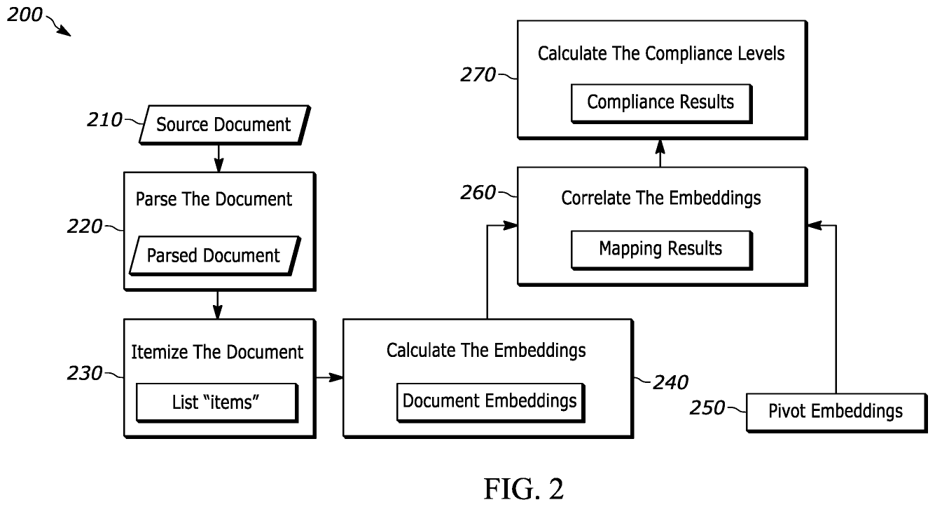

FIG. 2 illustrates a block diagram 200 of an embodiment of a system for cyber-risk quantification that gets a source document as an input and provides compliance-level results as output. A source document 210 represents a digital file that is a questionnaire or a cybersecurity policy. The source document 210 is a user-generated cybersecurity standard that is represented by text. Referring also back to FIG. 1B, the document upload engine 171 handles the source document 210 and sends it to the document parser engine 172. A parse the document module 220 in the document parser engine 172 parses the document based on the format of the document (e.g., PDF, XLSX, etc.) and also eliminates the parts of the document that cannot be or will not be used to determine the items.

The parse the document module 220 is in communication with an itemize the document module 230 also in the document parser engine 172. The parse the document module 220 sends the parsed document to the itemize the document module 230. The itemize the document module 230 determines the items of the document and produces the list of items and it is in communication with a calculate the embeddings module 240 in the embedding engine 173.

The calculate the embeddings module 240 gets the list of items from the itemize the document module 230 and calculates the embeddings for each item. The resulting document embeddings are stored in the embeddings database 175.

The correlate embeddings module 260 in the analyzer engine 176 fetches the document embeddings from embeddings database 175 and pivot embeddings 270 from the pivot embeddings database 174 and correlates the embeddings to determine the mappings. The correlate embeddings module 260 produces the mapping results and stores in mapping database 177.

The mapping engine 182 delivers the mapping results from mapping database 177 to a calculate the compliance module 270 in the compliance estimation engine 183. The calculate the compliance module 270 calculates the compliance level of an entity for a pivot standard.

FIG. 3 illustrates a block diagram 300 of an embodiment of a system for questionnaire and security policy cross-correlation and compliance level estimation that calculates compliance level of an entity for multiple standards according to the present teaching. This embodiment of the system depicts how a document is parsed and itemized. Referring also to FIG. 1B, all the modules depicted in the block diagram 300 of this illustration are in the document parser engine 172 except the detect document type module that is in the document upload engine 171.

A detect the document type module 310 determines the type of the document. For different types of the documents, a different series of actions may need to be taken to parse and itemize the document.

If the document type is XLSX, XLSM, or a similar format or CSV, TXT, or similar format, then the modules 321, 322, 323, 324, 325, 326 in processing block 320 are performed. If the document type is a rich text editor format such as PDF, MS DOCX, MS DOC, or similar, then the modules 331, 332, 333, 334 in processing block 330 are performed.

If the document type is XLSX, XLSM, or a similar format that supports multiple tables (e.g., multiple worksheets), then a convert to single table document module 321 converts the document a single table document type, e.g., CSV. The convert to single table document module 321 is communication with a determine the date of the document module 322 and sends to converted document to the determine the date of the document module 322.

If the document type is CSV, TXT, or similar, then the detect the document type module 310 sends the document directly to the determine the date of the document module 322.

The determine the date of the document module 322 checks the date value in any date field inside the document and gets the last modified date from the document attributes. It sets the date of the document according the following equation.

$$Document date = max ( the date value inside the document , last modified date )$$

A determine the questions column module 323 scans the columns to detect which column in the document represents the questions or control points. An example way of determining the questions column may be the scanning of the first three columns and selects the one with longer text average.

A determine the answers column module 324 scans the column to detect which column in the document represents the answers. An example method for such determination may be to search for keywords such as Yes, No, N/A, OK, X, or numerical values between 0 and 5, or numerical values between 0 and 100 with % sign, or decimal values between 0.0 and 1.0, or more complex keywords such as ad-hoc, non-compliant, basic, failed, defined, partial, poor, implemented, average, managed, measurable, good, optimized, compliant, excellent, etc.

A create items module 325 creates the list of items where each item has the following attributes: Area, Description, Item ID, Compliance, and Confidence. The area is a general scope that the items fall in (e.g., Access Control) if any area is specified. The create items module 325 scans the document to determine the area column, if any is present. The create items module 325 takes the data in the question columns for each item and assigns it as a Description attribute for that item. The create items module 325 assigns an item ID for each item that is unique within the document. The create items module 325 assigns 0 (zero) for both compliance and confidence attributes.

To calculate the compliance level for each item, module 326 calculates the compliance score in percentage based on the answer column. The score can be calculated by a preassigned value mapping for each keyword or a numerical value in the answers column. For example, if the answers column consists of only Yes and No answers, then Yes can be calculated as a 100% compliance score for that item, and No can be calculated as 0%.

Another example would be numerical answers with an integer value between 0 and 5. Then, 0 can be calculated as 0%, 1 as 20%, 2 as 40%, and so on.

Another example would be answers with pre-determined keywords such as non-compliant, failed, partial, poor, average, good, managed, compliant, etc. For each keyword, an appropriate compliance level can be pre-set.

To calculate the compliance level for each item, module 326 is in communication with a calculation the confidence level for each item in module 340 and sends the item list to this module.

If the document is in PDF, DOCX, or DOC format, the determine the document type module 310 sends the document to a determine the date of the document module 331. The determine the date of the document module 331 scans the “date” text in the document and gets the date next to this text and also gets the last modified date from the document attributes. It sets the date of the document according the following equation:

Document date=max(the date value inside the document,last modified date).

A determine the paragraphs that can be represented as items module 332 parses the document paragraph by paragraph and eliminates the paragraphs that cannot be an item. For example, eliminate the paragraphs with less than two words.

A create items module 333 creates the list of items where each item has following attributes: Area, Description, Item ID, Compliance, and Confidence. The area is general scope that the items fell in (e.g., Access Control) if any area is specified. The create items module 333 scans each item for a list of keywords that can be the area attribute. The create items module 333 takes the entire paragraph for each item and assigns it as a Description attribute for that item. The create items module 333 assigns an item ID for each item that is unique within the document. The create items module 333 assigns 0 (zero) for both compliance and confidence attributes.

A module 334 that calculates the compliance level for each item sets the compliance level as 100% for each item. The document submitted as PDF, DOCX, DOC, or similar rich-text formats are considered to include the cybersecurity policy rather than a questionnaire. Cybersecurity policies generally consist of the list of actions that an entity claims to execute in their organization. Thus, for each item mentioned in the security policy is considered to be present.

The module 334 calculates the compliance level for each item is in communication with a module 340 that calculate the confidence level for each item and sends the item list to this module. The module 340 that calculates the confidence level for each item computes the confidence level based on the date of the document. The older the document is the less confident level the answers have. An example of confidence level calculation may be the following equation:

$$Confidence = 2 - [ number of days ( today - document date ) / 365 ]$$

A create items list module 350 creates the list of items with following attributes: Area, Description, item ID, Compliance, Confidence. The create items list module 350 is in communication with embedding engine 173 described in connection with FIG. 1B.

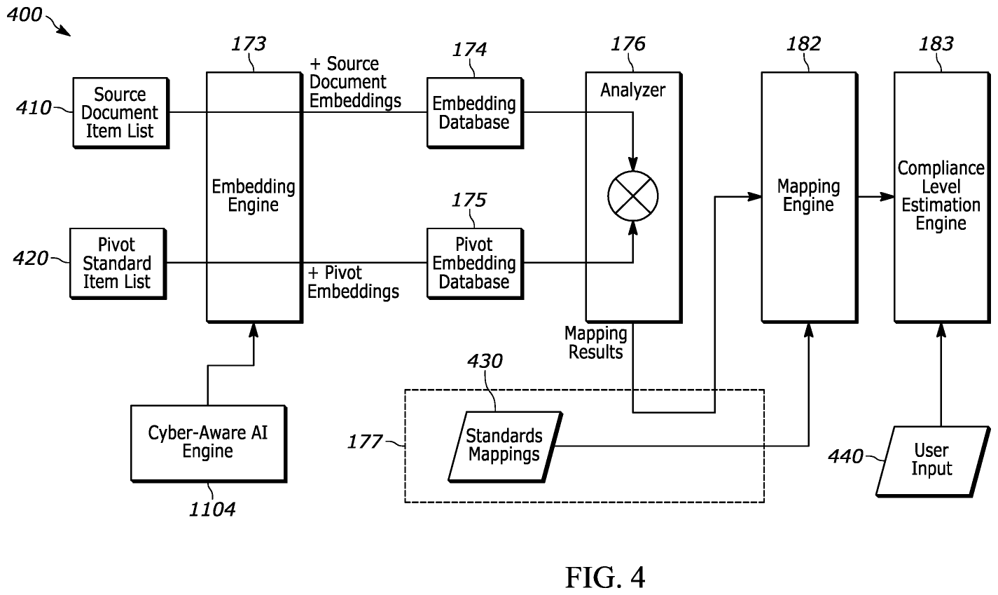

FIG. 4 illustrates a block diagram 400 of an embodiment of a system for questionnaire and security policy cross-correlation and compliance level estimation that calculates compliance level of an entity for multiple standards according to the present teaching. This embodiment of the system depicts how a source document is mapped to a pivot standard.

A source document item list 410 is generated, for example, by the create items list module 350 described in connection with FIG. 3. Referring also to FIG. 1B, a pivot standard item list 420 is stored in pivot standard database 140. Both the source document list 410 and the pivot standard list 420 are fetched by the embedding engine 173. The embedding engine 173 is provided models from the cyber-aware AI engine 1104 of the cyber-aware system 1100 that is described in connection with FIGS. 1A-B. The efficiency and reliability of the embedding engine 173 is improved by incorporating the received models from the cyber-aware AI-engine 1104.

The embedding engine 173 calculates the embeddings for the description attribute of each item. An embedding is a 512-dimensional array to represent the text in computable numerical values in double format.

For example, for the input “Description”: Maintain strict control over the storage and accessibility of media.”, the embedding output is [−0.0310460310429346, 0.02373965643463097, 0.0456372429601364, . . . ] that has 512 values where . . . represents the rest of the values omitted here due to space restrictions.

The list of items with their embedding counterparts are stored in the embeddings database 174 for the source document 410 and in the pivot embedding database 175 for the pivot standard 420.

The analyzer 176 fetches the source document embeddings and the pivot embeddings. The analyzer 176 correlates each item from the source document embeddings to each item in the pivot embeddings. For example, the correlation can be done by taking the inner product of the embedding results. Based on the results, the analyzer creates a mapping between source document items and the pivot document items. The compliance value for the pivot standard items are equal to the compliance value of the mapped source document items.

The mapping results are stored in the mapping database 177. The mapping engine 182 fetches the mapping results from the mapping database 177 and transfers the results of the requested standard's item list to compliance estimation engine 183. The compliance estimation engine 183 computes the compliance level of the pivot standard based on the compliance values of each item. For example, the compliance level may be calculated as average values of compliance values of the items.

The compliance estimation engine 183 requests the item lists for other standards from the mapping engine 182. The mapping engine fetches the standards mapping 430 that includes the mapping results from one standard to another. The mapping engine 182 creates a list of items for the requested standard by setting the compliance values of each item for the requested standard based on the compliance values of mapped items in the pivot standard. The compliance estimation engine 183 keeps requesting the item lists until the compliance level is calculated for all the standards defined in the system.

A user input 440 sent from user input/output interface 184 can change the compliance values of one or more item in the compliance estimation engine 183. In response to the user request, the compliance estimation engine 183 changes the compliance item and requests re-calculated compliance values for each standard defined in the system from the mapping engine 177.

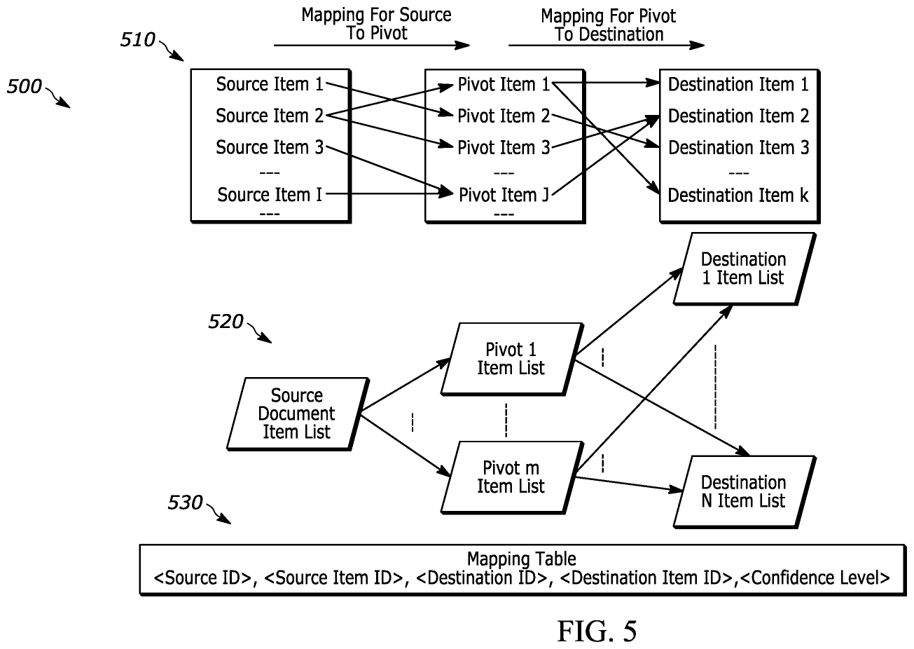

FIG. 5 illustrates a block diagram 500 of an embodiment of a system for questionnaire and security policy cross-correlation and compliance level estimation that calculates compliance level of an entity for multiple standards according to the present teaching. This embodiment of the system depicts example mappings from source document to pivot standard and pivot standard to another standard in 510.

In the present teaching, not all standards defined in the system have direct correlation with all the other standards. Such one-to-one mapping may increase the size of mapping tables tremendously where maintaining and scaling such tables would be extremely difficult. Therefore, a source document has mappings to one or more pivot standards and each pivot standard has mappings to one or more other standards as depicted in 520. The mapping database 177 described in connection with FIG. 1B keeps records of mapping tables 530 where each entry has at least following attributes: source ID, source item ID, destination ID, destination item ID, and confidence level.

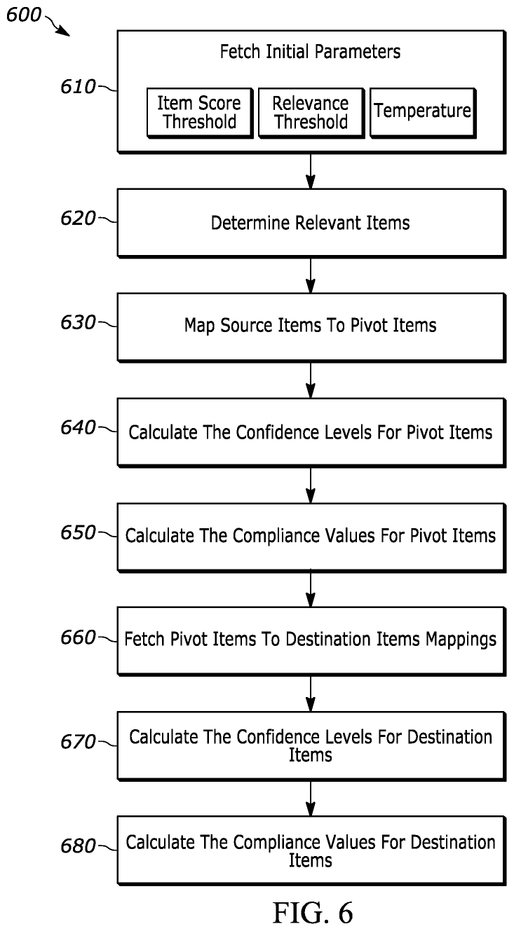

FIG. 6 illustrates a block diagram 600 of an embodiment of a system and method for questionnaire and security policy cross-correlation and compliance level estimation that calculates compliance level of an entity for multiple standards according to the present teaching. This embodiment of the system depicts the flow diagram of mapping from a source document to a non-pivot standard called destination in the block diagram.

A fetch initial parameters module 610 in the analyzer 176 described in connection with FIG. 1B gets the parameters to initiate the mapping. Some example parameters are item score threshold, relevance threshold, and temperature of the source document. The term “item score threshold” used herein refers to what is the minimum item similarity score that will be included in the compliance calculation. Items below the threshold value will not be the part of cross correlation. The term “relevance threshold” used herein refers to what is the minimum item relevance score that will be included in the compliance calculation. Items that don't have enough relevance will not be candidates for direct or indirect mapping. The term “temperature” used herein refers to how objective or subjective the semantic analysis engine will compare the file content with the compliance control items. The higher the tolerance is; the more subjective results are.

A determine relevant items module 620 determines the items in the pivot item whose item score is above the item score threshold and relevance is above the relevance threshold for each item in the source document.

A map source items to pivot items module 630 maps each item in the source items list to relevant items determined by the determine relevant items module 620. Then, a calculate the confidence levels module 640 calculates the confidence level for each item in the pivot item list.

Referring also to FIG. 1B, the modules 610, 620, 630, and 640 are in the analyzer engine 176. The results produced by these modules are stored in the mapping engine 177. The mapping engine 182 fetches the mapping results from source item list to pivot item list. A calculate the compliance values for pivot items module 650 in the mapping engine 182 assigns the compliance values of the source items to their mapped pivot items based on the mapping results.

A fetch pivot items to destination items mapping module 660 in the mapping engine 182 gets the mapping from pivot item list to destination item list. A calculate the confidence levels for destination items module 670 in the mapping engine 182 assigns the confidence levels of the pivot items to their mapped destination items based on the mapping results. Similarly, a calculate the compliance values for destination items module 680 in the mapping engine 182 assigns the compliance values of the pivot items to their mapped destination items based on the mapping results.

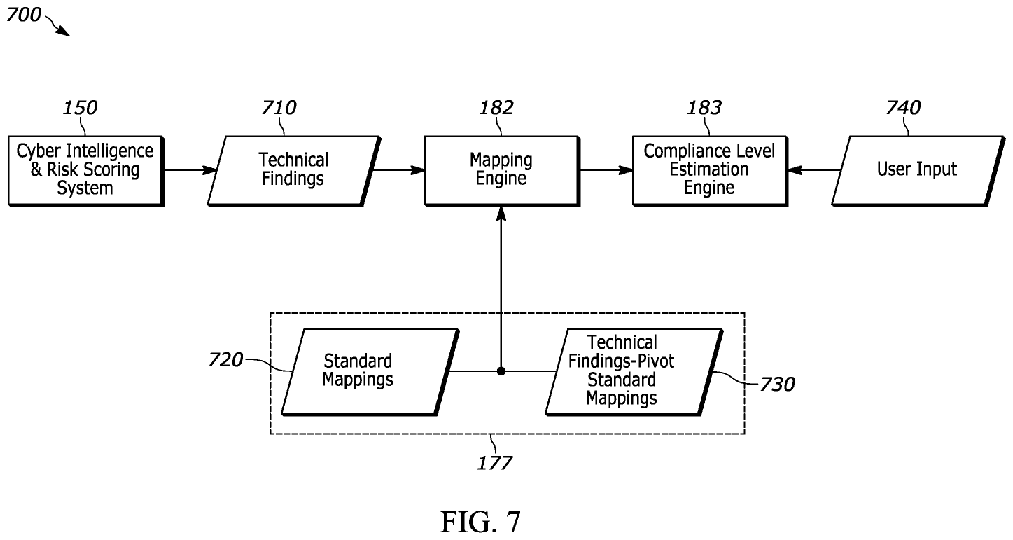

FIG. 7 illustrates a block diagram 700 of an embodiment of a system for questionnaire and security policy cross-correlation and compliance level estimation that calculates compliance level of an entity for multiple standards according to the present teaching. This embodiment of the system depicts how the system calculates the compliance levels.

Referring also to FIG. 1B, the cyber intelligence and risk scoring system 153 produces the technical findings 710. The mapping engine 182 fetches the technical findings 710 and the technical findings to pivot standards mapping 730 from mapping database 177. The compliance value of each item mapped from a technical finding to an item in the pivot list is calculated based on the result of the technical finding. For example, a “failed” result of a technical finding results in 0% compliance value of the mapped pivot items. Similarly, a “passed” result of a technical finding results in 100% compliance value of the mapped pivot items. For any pivot item that is not mapped to a technical finding, the compliance value is left null.

The mapping engine 182 sends the pivot item lists to the compliance level estimation engine 183 until all the pivot standards' compliance levels are calculated. Then, the mapping engine 182 fetches the standard mappings 720 from mapping database 177 that shows the mapping results from a pivot standard to the destination standard and calculates the compliance values for each item in the destination standard.

The mapping engine 182 sends the item lists of the standards to the compliance level estimation engine 183 until all the standards' compliance levels are calculated. That is, multiple standard compliance levels can be generated, each associated with a different standard.

In some embodiments, users can upload policy documents to the universal questionnaire and policy examiner system 170 using an “Upload File” button of a graphical user interface. The uploaded policy file could either be in numerous know formats, including, for example, various document and spreadsheet formats (e.g. XLSX, XLS, CSV, XLSM, PDF, DOCX, DOC, or TXT file formats). A pop-up will be displayed in the graphical user interface so the user can select the file as well as set a tolerance limit. The tolerance limit sets the objectivity of the mapping calculation. A higher tolerance limit will yield more correlations, increasing the subjectivity of the calculation. A lower tolerance limit will look for more accrue similarity and thus will yield fewer correlations.

To illustrate the operation, we describe a case in which the user uploads Example Corp.'s policy file named “example_policy.docx.” The document parser engine 172 does the following operations respectively. First, the engine 172 parses paragraphs in this file. If the engine 172 can detect headings, it identifies them as an area and it records them as “area name”. As the engine 172 finds more paragraphs under an area, it appends the paragraphs under this heading—so it can calculate and area_scoring. An area_scoring represents the area similarity in addition to item similarity in later steps. In some embodiments, the identified areas are the same as a compliance item type, or category. If the engine 172 cannot detect headings, it runs calculations free of area scoring in other steps.

The document parser engine 172 hands over the process to embedding engine and analyzer 176. The analyzer engine 176 calculates area scoring and item scoring for each paragraph. For the example, the document parser engine 172 detected ninety-seven items to be mapped to the standards.

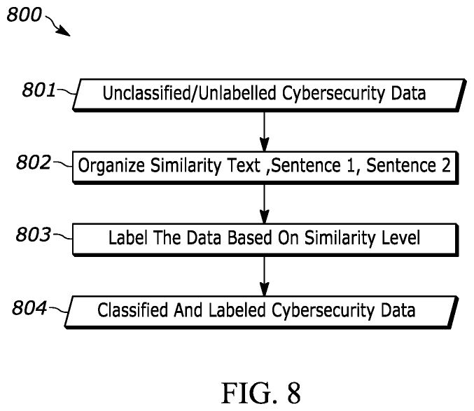

FIG. 8 illustrates the classification procedure of cybersecurity data in Classification Engine 1101 described in connection with FIG. 1B. The unclassified/unlabeled cybersecurity data 801 can be created by subject matter experts or curated data from cyberspace or both. Referring also to FIG. 1A, for example, the cybersecurity data 801 can be one or more of various standard compliance items generated by the standards and framework database system 140. For example, the cybersecurity data 801 can be one or more of user compliance levels and/or standard compliance levels calculated by the compliance estimation system 180. The unclassified/unlabeled cybersecurity data 801 can then be organized based on similarity (802) by the classification engine 1101 and labeled in with respect to the similarity levels. The results of the algorithm illustrated in FIG. 8 are classified and labeled cybersecurity data that includes, for example, the similarity between two sentences in a training data set.

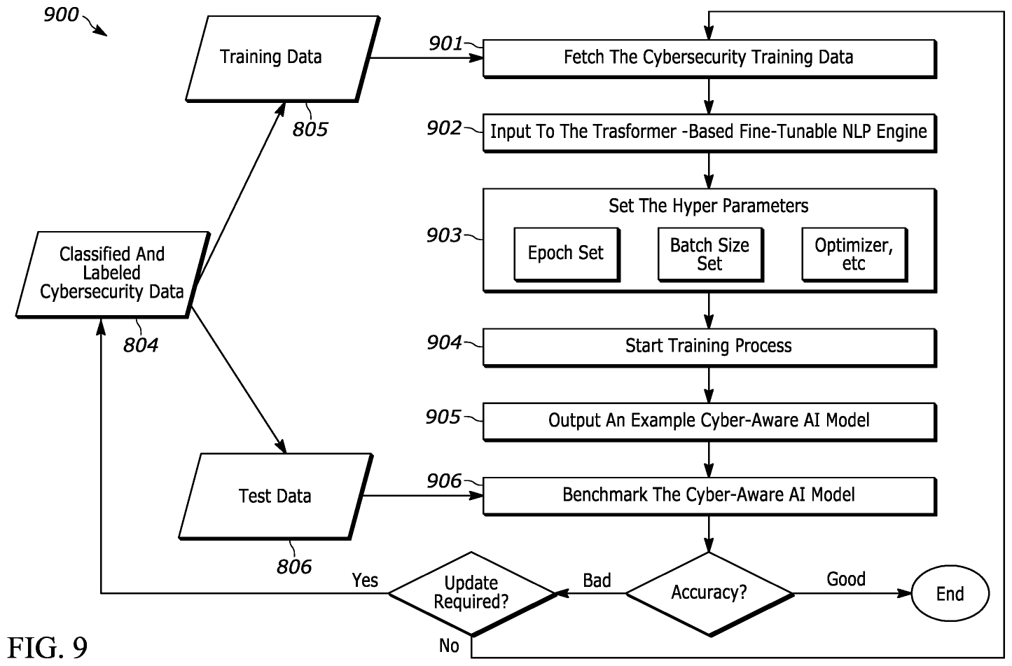

FIG. 9 illustrates an embodiment of training and model set up 900 for a cyber-aware artificial intelligence engine according to the present teaching. Referring also to FIG. 1B, the classified and labeled cybersecurity data 804 produced by classification engine 1101 is split as training data and testing data. The engine fetches the training data and inputs it into the transformed-based fine-tunable NLP engine 902. The NLP engine sets the hyper parameters such as batch size, epochs, and optimizer, etc., and then the training process 904 starts. Then, the engine outputs an example cyber-aware AI model 905, which must be benchmarked and tested for accuracy. The test data is fetched, which is used in benchmarking 906. If the benchmark results' accuracy is over a certain threshold (i.e., the accuracy is good), then the model is transferred to embedding engine 173. If not, there are different alternatives from this step on. Either the cybersecurity data needs to be updated, meaning a different cybersecurity data will be prepared, 804, or the process 900 starts all over again with different hyper parameters, 903.

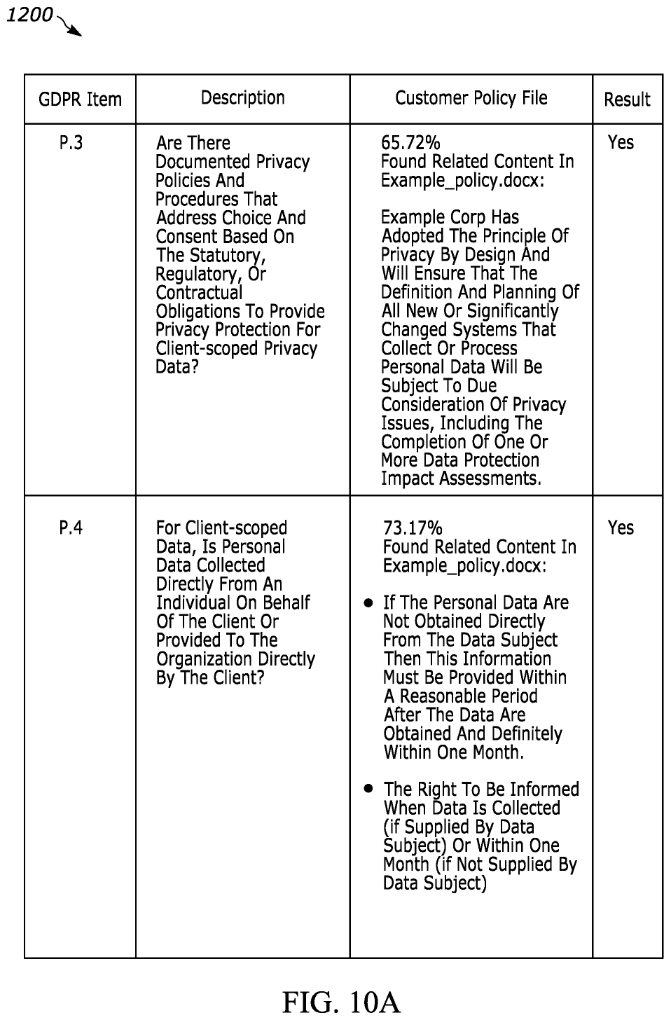

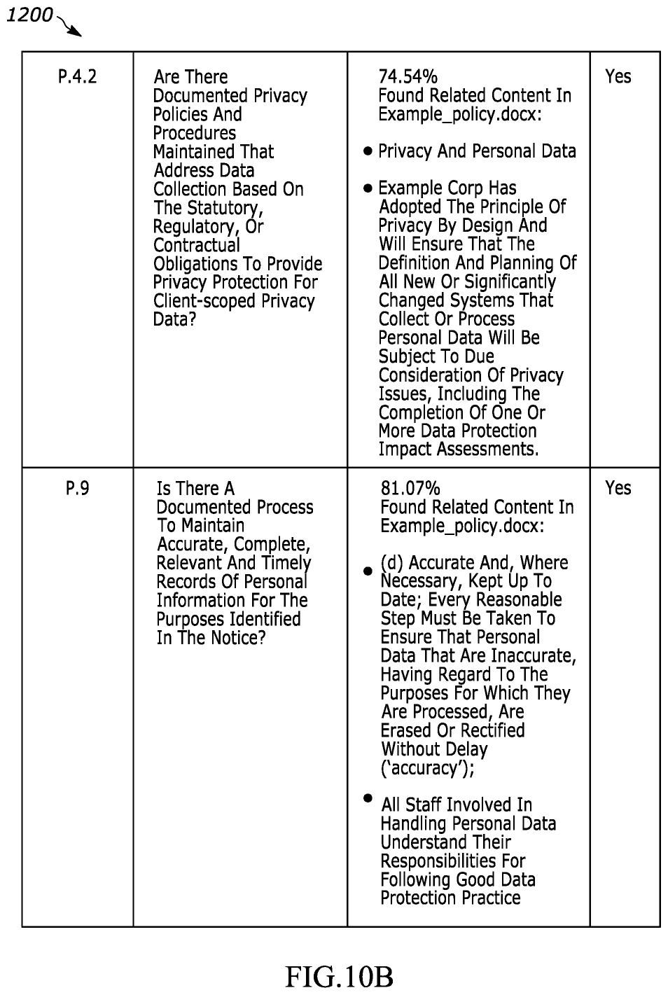

FIG. 10A illustrates part of a table 1200 showing the mappings of an uploaded file to a General Data Protection Regulation (GDPR) at an output of a document parser engine according to the present teaching. FIG. 10B illustrates a continuation of the table 1200 showing the mappings of an uploaded file to a General Data Protection Regulation (GDPR) at an output of a document parser engine of FIG. 10A. FIGS. 10A-B show the mappings of an uploaded file to a General Data Protection Regulation (GDPR) at an output of the document parser engine 172. In this example, the engine 172 discovers mappings between the items for General Data Protection Regulation and example_policy.docx. Each GDPR item, a description of the item, the related customer policy discovered in the example_policy.docx and the result are shown for four items.

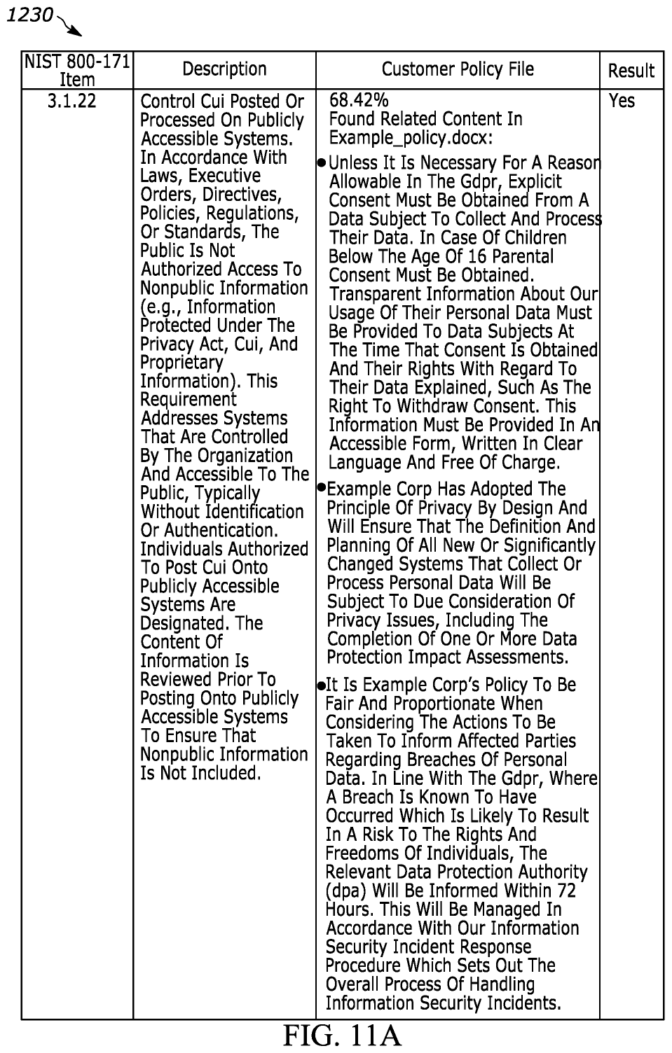

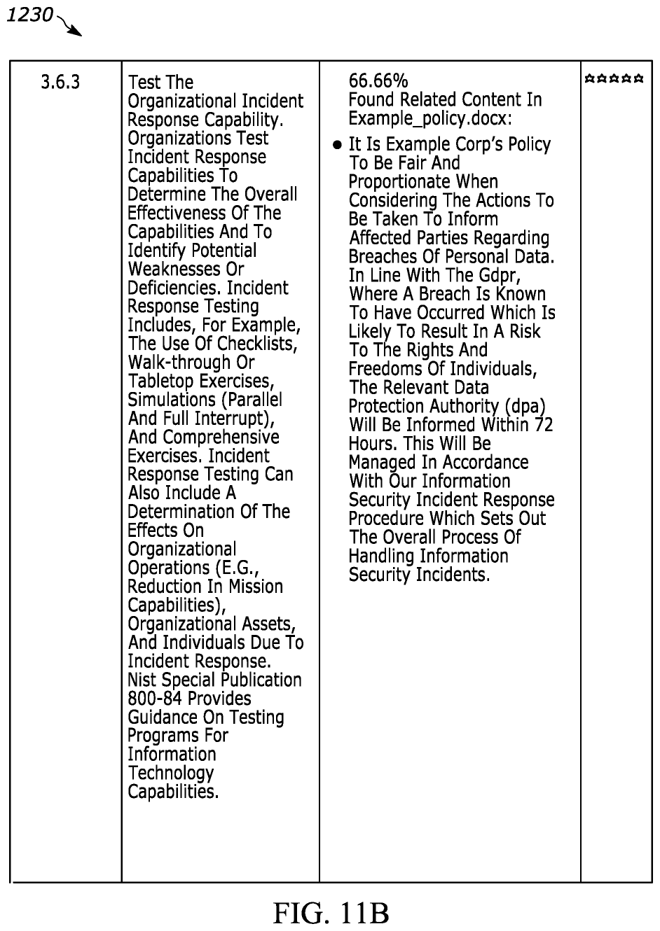

FIG. 11A illustrates a continuation of a table 1230 showing the mappings of an uploaded file from a National Institute of Standards and Technology (NIST) standard at an output of a document parser engine 172 according to the present teaching. FIG. 11B illustrates a continuation of the table 1230 showing the mappings of an uploaded file from a National Institute of Standards and Technology (NIST) standard at an output of a document parser engine 172 of FIG. 11A. In this example, the engine 172 discovers mappings between the items for NIST 800-171 and example_policy.docx. Each NIST 800-171 item, a description of the item, the related customer policy discovered in the example_policy.docx, and the result are shown for two items.

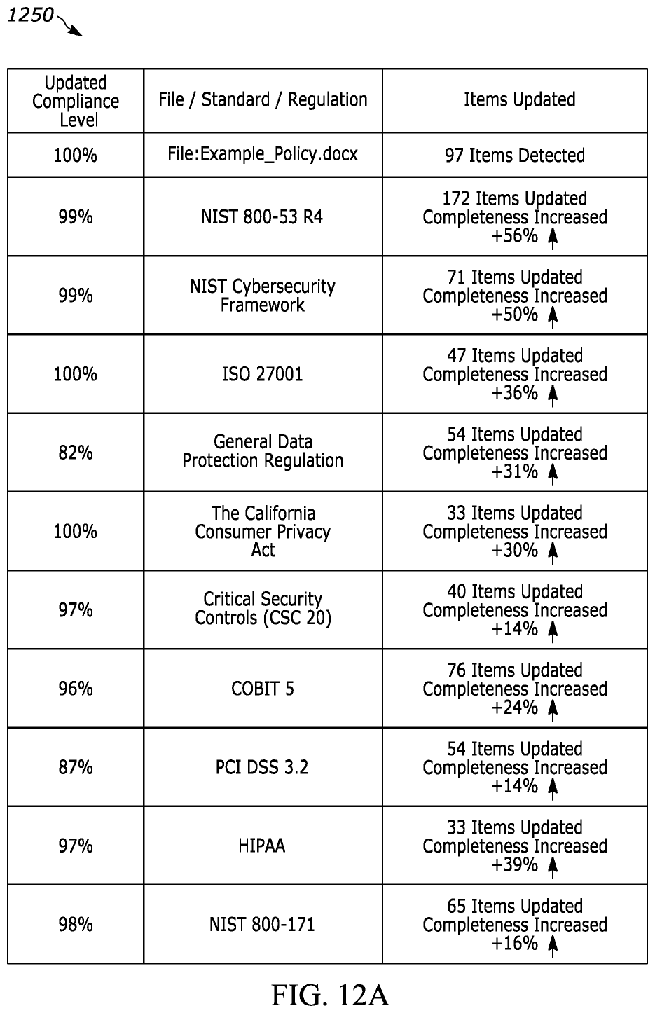

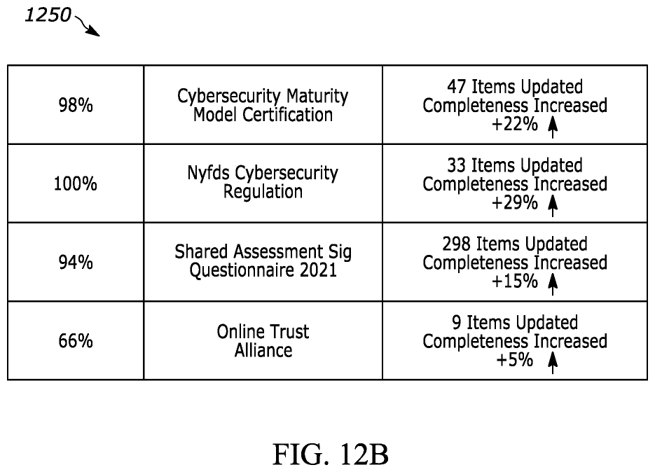

FIG. 12A illustrates a table 1250 showing the effect of the compliance and completeness level of standards at an output of an embodiment of a policy examiner system according to the present teaching. FIG. 12B illustrates a continuation of the table 1250 showing the effect of the compliance and completeness level of standards at an output of an embodiment of a policy examiner system of FIG. 12A. This table 1250 shows, overall, and how the policy file, example_policy.docx, affected the compliance and completeness level of standards. When the user clicks save results, a dashboard will be updated with the above compliance and completeness levels and will be displayed to the user. When the user clicks in a region of a GUI associated with “save results”, the dashboard will be updated with the above compliance and completeness levels and will be displayed to the user on a graphical user interface.

One feature of the method of cyber risk assessment of the present teaching is that it helps organizations to identify and remedy potential gaps in a cyber-infrastructure that is desired to be compliant with a particular standard. In general, organizations prepare cyber security programs to align various aspects of the computer infrastructure, processes and devices to internal and/or external security frameworks. Thus, the cyber risk assessment of the present teaching allows changes in the cyber systems to better align with the desired security, or other compliance, framework. For example, specific actions on cyber systems as a result of the assessment can bolster compliance with a Security Rule and improve an entity's ability to secure sensitive information from a broad range of cyber threats. A compliance correlation provides a flexible, scalable and, in some cases, technologically-neutral assessment of a cyber-system.

One feature of the present teaching is that it allows an entity to accommodate integration with multiple detailed frameworks, including, for example, NIST 800-53, PCI-DSS, ISO 27001, COBIT, GDPR, and Share Assessments. Compliance and completeness of coverage of a standard, for example, NIST 800-53, NIST CSF, ISO 27001, GDPR, CCPA, CIS CSC-20, COBIT 5, PCI-DSS, HIPAA, NIST 800-171, CMMC, NY DFS, and/or SA-2022 can be supported. The cyber risk assessment of the present teaching supports the de-duplication of assessment from different, but in some cases similar and/or overlapping, standards and best practices.

### EQUIVALENTS

While the Applicant's teaching is described in conjunction with various embodiments, it is not intended that the applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A method of cyber risk assessment, the method comprising:
a) storing a plurality of standard compliance items in a database;
b) generating an embedding modelling system using at least one of a standard compliance item retrieved from the database, a first model embedded user compliance level, or a first model embedded standard compliance level;
c) uploading a user cybersecurity standard comprising a user compliance item represented by text and converting the text to a numeric array to generate an embedded user compliance item using the generated embedded modelling system;
d) retrieving from the database a standard compliance item represented by text and converting the text to a numeric array to generate an embedded standard compliance item;
e) correlating the embedded user compliance item and the embedded standard compliance item to generate a compliance item map;
f) determining at least one of a second model user compliance level or a second model standard compliance level based on the generated compliance item map;
g) generating an improved embedding modelling system using at least one of the determined second model user compliance level or the second model standard compliance level;
h) discovering a digital footprint of an entity based on an associated domain name using non-intrusive information gathering;
i) generating an entity technical finding based on the discovered digital footprint of the entity and a control item;
j) computing an entity compliance level estimate based on the compliance item map and the entity technical finding; and
k) adjusting a computer process of the entity based on the computed entity compliance level estimate.

2. The method of cyber risk assessment of claim 1 wherein the correlating the embedded user compliance item and the embedded standard compliance item to generate the compliance item map comprises correlating such that the compliance item map comprises a compliance item for each user compliance item in the user cybersecurity standard and comprises a compliance item for each standard compliance item in the database such that the compliance item map includes only one compliance item of a same compliance item type.

3. The method of cyber risk assessment of claim 1 wherein generating the embedding modelling system using at least one of the standard compliance item retrieved from the database, the first model embedded user compliance level, or the first model embedded standard compliance level comprises a training step.

4. The method of cyber risk assessment of claim 3 wherein the training step comprises training using a Natural Language Processing (NLP) model.

5. The method of cyber risk assessment of claim 1 wherein generating the embedding modelling system using at least one of the standard compliance item retrieved from the database, the first model embedded user compliance level, or the first model embedded standard compliance level comprises a testing step.

6. The method of cyber risk assessment of claim 1 wherein generating the embedding modelling system using at least one of the standard compliance item retrieved from the database, the first model embedded user compliance level, or the first model embedded standard compliance level comprises a benchmarking step.

7. The method of cyber risk assessment of claim 6 wherein the benchmarking step is performed before the uploading the user cybersecurity standard comprising the user compliance item represented by text and converting the text to the numeric array to generate the embedded user compliance item using the generated embedded modelling system.

8. The method of cyber risk assessment of claim 1 wherein the generating the improved embedding modelling system is performed continuously.

9. The method of cyber risk assessment of claim 1 further comprising classifying the at least one of the standard compliance item retrieved from the database, the first model embedded user compliance level, or the first model embedded standard compliance level used to generate the embedding modeling system.

10. The method of cyber risk assessment of claim 9 wherein the classifying determines a similarity between text within the at least one of the standard compliance item retrieved from the database, the first model embedded user compliance level, or the first model embedded standard compliance level used to generate the embedding modeling system and text in a training data set.

11. The method of cyber risk assessment of claim 1 wherein at least one of the user compliance item and the standard compliance item comprises at least one of a network security process, a threat detection process, or a data storage process.

12. The method of cyber risk assessment of claim 1 wherein the adjusting the computer process of the entity comprises adjusting at least one of a network security process, a threat detection process, or a data storage process.

13. The method of cyber risk assessment of claim 1 wherein the control item comprises at least one of vulnerability, a cyber-event, or a reputation.

14. The method of cyber risk assessment of claim 1 wherein the entity technical finding comprises at least one of a misconfiguration, an asset vulnerability, a threat, a data loss, or a cyber-event.

15. The method of cyber risk assessment of claim 2 wherein the same compliance item type comprises at least one of a data protection, an endpoint security, or a network security.

16. The method of cyber risk assessment of claim 1 further comprising generating the user cybersecurity standard based on a document.

17. The method of cyber risk assessment of claim 16 wherein the document is a questionnaire.
